(19) United States
(12) Patent Application Publication
(10) Pub. No.: US 2012/0092548 A1
(43) Pub. Date: Apr. 19, 2012

(54) IMAGE-ACQUISITION APPARATUS AND IMAGE-ACQUISITION METHOD

(76) Inventors: Kohei Kawazoe, Nagasaki (JP); Tomoyoshi Baba, Nagasaki (JP); katsutoshi Ochiai, Nagasaki (JP); Kiyotoshi Nishimura, Nagasaki (JP); Toshiyuki Yamada, Nagasaki (JP)

(21) Appl. No.: 13/131,055

(22) PCT Filed: Dec. 18, 2009
(86) PCT No.: PCT/JP2009/071098

§ 371 Date: Jun. 16, 2011

(30) Foreign Application Priority Data
Dec. 18, 2008 (JP) 2008322697

(51) Int. Cl. H04N 5/222

(52) U.S. Cl. 348/370; 348/E05.029

(57) ABSTRACT

A needless irradiation region in an image-acquisition apparatus is reduced. Provided is a light-transmitting portion that radiates light and a light-receiving portion that receives reflected light, which is the light emitted from the light-transmitting portion being reflected upon reaching a target, and that converts the obtained reflected light to an image signal and outputs the image signal. The light-transmitting portion includes an irradiation scanning section that makes an irradiation region for a field of view smaller than the size of the entire field of view and that irradiates the entire field of view with light by scanning the irradiation region for the field of view.

### TECHNICAL FIELD

The present invention relates to an image-acquisition apparatus and an image-acquisition method.

### BACKGROUND ART

Conventionally, in laser radar systems and surveillance cameras such as video cameras, the field of view of the camera is irradiated by a light source to make the image easier to see. When the region irradiated by this light source is circular, as shown in FIG. 15, it is irradiated in such a way that the field of view of the camera is contained inside the circular irradiation region, and the entire field of view is irradiated.

### CITATION LIST

### {Patent Literature}

{PTL 1} Japanese Unexamined Patent Application, Publication No. 2003-149717

### SUMMARY OF INVENTION

### Technical Problem

With the conventional method, however, there is a problem in that much of the irradiation region lies outside the field of view of the camera, resulting in a high level of wasted irradiation energy. Furthermore, as the field of view increases, the outlying irradiation region increases, resulting in the problem that the wasted irradiation energy further increases. For example, if the field of view of the camera increases two-fold, the area irradiated by light increases four-fold, and therefore, to obtain the same image quality as the image quality with the field of view of the original size, the irradiation energy of the light source must increase four-fold. When the field of view is enlarged in this way, the irradiation energy of the light source to cover it increases in proportion to the square of the enlargement factor.

The present invention has been conceived to solve the above-described problem, and an object thereof is to provide an image-acquisition apparatus and image-acquisition method that can reduce the size of a needless light irradiation region, thus reducing the increase in light irradiation energy required when enlarging the field of view.

### Solution to Problem

In order to solve the problem, the present invention employs the following solutions.

An aspect of the present invention is an image-acquisition apparatus including a light-transmitting portion that radiates light and a light-receiving portion that receives reflected light, which is the light emitted from the light-transmitting portion being reflected upon reaching a target, and that converts the obtained reflected light to an image signal and outputs the image signal. The light-transmitting portion includes a light source and an irradiation scanning section that makes an irradiation region for a field of view smaller than the size of the entire field of view and that irradiates the entire field of view with light by scanning the irradiation region for the field of view within the field of view.

According to this configuration, the light emitted from the light-transmitting portion reaches the target and is reflected therefrom, and this reflected light is received by the light-receiving portion. The light-receiving portion converts the received reflected light into an image signal and outputs the image signal. In this case, because the irradiation scanning section makes the irradiation region for the field of view smaller than the size of the entire field of view and irradiates the entire field of view with light by scanning this irradiation region, it is possible to reduce the region lying outside the field of view compared with the conventional method in which the entire field of view is irradiated. Thus, it is possible to reduce the amount of wasted irradiation energy.

In the above-described image-acquisition apparatus, the irradiation scanning section may make the length of the diameter of the irradiation region for the field of view substantially equal to the length of any one side of the sides constituting the field of view.

In this way, the length of the diameter of the irradiation region for the field of view is made substantially equal to the length of any one side of the sides constituting the field of view. Thus, it is possible to further reduce the amount of wasted irradiation energy.

In the above-described image-acquisition apparatus, the irradiation scanning section may includes a lens and may move the lens parallel to an optical axis to adjust the size of the irradiation region for the field of view.

In this way, it is possible to adjust the size of the irradiation region for the field of view with a simple method.

In the above-described image-acquisition apparatus, the irradiation scanning section may include at least two lenses with different irradiation angles which can be inserted on an optical axis and may adjust the size of the irradiation region for the field of view by selecting one of the lenses and inserting the selected lens on the optical axis.

In this way, it is possible to adjust the irradiation region for the field of view with a simple method.

In the above-described image-acquisition apparatus, the irradiation scanning section may define any one of the sides constituting the field of view as a reference side and may make the length of the diameter of the irradiation region for the field of view substantially equal to the length of the reference side and may scan the illumination region for the field of view in a direction perpendicular to the reference side.

In this way, with one of the sides constituting the field of view defined as a reference side, the size of the irradiation region is adjusted so as to have a diameter substantially equal in size to the length of this reference side, and this irradiation region is scanned in a direction perpendicular to the reference side; therefore, it is possible to further reduce the amount of wasted irradiation energy.

In the above-described image-acquisition apparatus, the irradiation scanning section may include a lens group including a plurality of lenses arranged on the optical axis and may moves at least one of the lenses included in the lens group in a direction perpendicular to the optical axis to scan the irradiation region in the field of view.

In this way, it is possible to scan the irradiation region for the field of view with a simple method.

In the above-described image-acquisition apparatus, the moving speed of at least one lens of the lens group may be adjustable.

In this way, for example, when the moving speed of the first lens is changed to increase the speed, the number of times that the field of view is irradiated per unit time is increased. Thus, it is possible to obtain a brighter image, and it is possible to obtain a higher-quality image.

In the above-described image-acquisition apparatus, the irradiation scanning section may include a first mirror that reflects light from the light source and a second mirror that reflects the light that the first mirror has reflected, and may scan the irradiation region within the field of view while changing the irradiation angle of the light by rotating the second mirror.

In this way, the light from the light source, which is reflected by the first mirror, is reflected by the second mirror. The irradiation region for the field of view is scanned by rotating the second mirror. Accordingly, it is possible to scan the irradiation region for the field of view with a simple method.

In the above-described image-acquisition apparatus, the speed at which the second mirror is rotated may be adjustable.

In this way, when the rotation speed of the second mirror is increased, the number of times the field of view is irradiated per unit time is increased. Thus, it is possible to obtain a brighter image, and it is possible to obtain a higher-quality image.

In the above-described image-acquisition apparatus, the irradiation scanning section may include a beam-shape modifying section that modifies the cross-sectional shape obtained when cutting through the light output from the light source in a direction perpendicular to the optical axis and that makes the irradiation region for the field of view smaller than the size of the entire field of view to reduce the area of the cross-sectional shape.

In this way, in the irradiation scanning section, the cross-sectional shape of the light output from the light source in a direction perpendicular to the optical axis is modified, and the irradiation region for the field of view is made smaller than the size of the entire field of view, thus reducing the area of the cross-sectional shape; therefore, the irradiation energy is concentrated. Accordingly, it is possible to increase the brightness of the irradiation region compared with a case where the cross-sectional shape is not modified. In addition, the method of modifying the shape of the beam may be a method using, for example, a cylindrical lens, a slit, or the like.

In the above-described image-acquisition apparatus, the light-transmitting portion may include an optical fiber bundle in which the light emitted from the light source is guided, and the optical fiber bundle may be bundled so that the cross section at the output end thereof is elliptical.

In this way, by bundling the end faces at the output end of the optical fiber bundle that guides the light emitted from the light source so as to form an elliptical shape, the irradiation region of the light radiated from the optical fiber bundle takes an elliptical shape. Thus, it is possible to modify the cross-sectional shape of the irradiation region in a simple manner.

An aspect of the present invention provides an image-acquisition method including a step of radiating light; a step of receiving reflected light, which is the emitted light reflected upon reaching a target, converting the obtained reflected light to an image signal, and outputting the image signal; and a step of making an irradiation region for an field of view smaller than the size of the entire field of view and irradiating the entire field of view with light by scanning the irradiation region for the field of view within the field of view.

### Advantageous Effects of Invention

According to the present invention, an advantage is afforded in that it is possible to obtain a clear image while reducing the amount of wasted irradiation energy.

### BRIEF DESCRIPTION OF DRAWINGS

FIG. 1 is a block diagram showing, in outline, the configuration of an image-acquisition apparatus according to a first embodiment of the present invention.

FIG. 2 is a diagram showing an example of the positional relationship between the placement of a transmitted-light lens and a scanning mechanism in the image-acquisition apparatus according to the first embodiment of the present invention.

FIG. 3 is a diagram showing an example of a small irradiation region for the field of view.

FIG. 4 is a diagram showing an example of scanning of the irradiation region inside the field of view.

FIG. 5 is a diagram showing an example in which the incident positions of light rays on a lens differ.

FIG. 6 is a timing chart for explaining one frame of a CCD camera, pulse timing of the laser light output from a semiconductor laser, and opening/closing timing of a shutter device.

FIG. 7 is a diagram showing an example of a table in which the surveillance field of view and transmitted-light lens position are associated with each other.

FIG. 8 is a diagram showing an example in which the size of the irradiation region is changed using lenses with different irradiation angles.

FIG. 9 is a diagram showing an example of the positional relationship for the placement of a transmitted-light lens and a scanning mechanism in an image-acquisition apparatus according to a second embodiment of the present invention.

FIG. 10 is a diagram showing an example of a region irradiated by a beam-shape modifying section.

FIG. 11 is a diagram showing an example of the relationship between the laser (field of view) divergence angle and laser output power.

FIG. 12 is a diagram showing an example of the relationship between the horizontal direction of the field of view and the image brightness distribution.

FIG. 13 is a diagram showing an example in which the cross-section of a bundle of optical fibers is elliptical.

FIG. 14 is a diagram showing an example in which an irradiation scanning section is provided with a mirror, in an image-acquisition apparatus according to a third embodiment of the present invention.

FIG. 15 is a diagram showing an irradiation region for the field of view in the related art.

### DESCRIPTION OF EMBODIMENTS

Embodiments of an image-acquisition apparatus according to the present invention will be described below with reference to the drawings.

In these embodiments, a description is given for the case where it is applied to a surveillance apparatus based on laser radar, but the present invention can be widely applied to general image-acquisition devices as a whole, such as video cameras, for example.

### First Embodiment

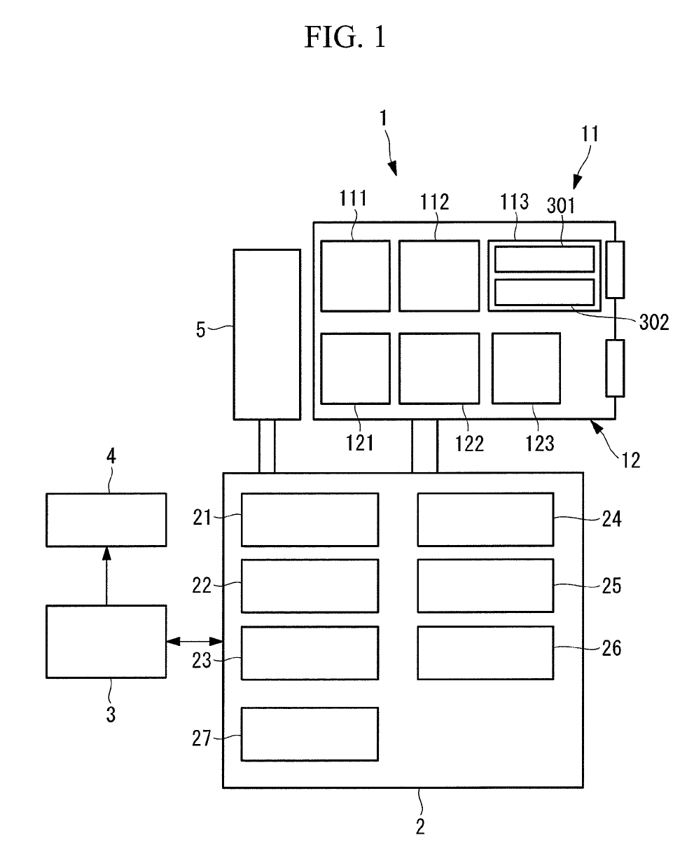

FIG. 1 is a block diagram showing, in outline, a laser radar according to a first embodiment.

As shown in FIG. 1, the image-acquisition apparatus according to this embodiment includes a laser radar 1, a laser-radar control unit 2, a control device 3, and a display device 4. The laser radar 1 is configured to include a light-transmitting portion 11 and a light-receiving portion 12.

The light-transmitting portion 11 includes a laser oscillator (light source) 111, a transmitted-light shutter 112, an irradiation scanning section 113, and a transmitted-light lens actuator (not illustrated) as main components.

The laser oscillator 111 is a compact laser light source, for example, a semiconductor laser, which receives electricity supplied from a laser power supply 26 in the laser-radar control unit 2, described later, and emits laser light, which is continuous light.

The transmitted-light lens actuator controls the irradiation scanning section 113 on the basis of a control signal supplied from an irradiation scanning controller 27 in the laser-radar control section 2, described later. Accordingly, the irradiation region of light radiated outside via the irradiation scanning section 113 can be adjusted to a desired area.

The transmitted-light shutter 112 is provided between the laser oscillator 111 and the irradiation scanning section 113 and is subjected to on/off control in synchronization with a received-light shutter 122 provided in the light-receiving portion 12, described later. Specifically, on/off control is performed by a shutter-device control section 24 in the laser-radar control unit 2, described later.

The irradiation scanning section 113 includes a transmitted-light lens system 301 and a scanning mechanism 302. The irradiation scanning section 113 radiates laser light emitted from the laser oscillator 111 towards a target object and scans the irradiation region. Also, by making the irradiation region for the field of view smaller than the entire field of view and scanning the irradiation region for the field of view, the light irradiates the entire field of view.

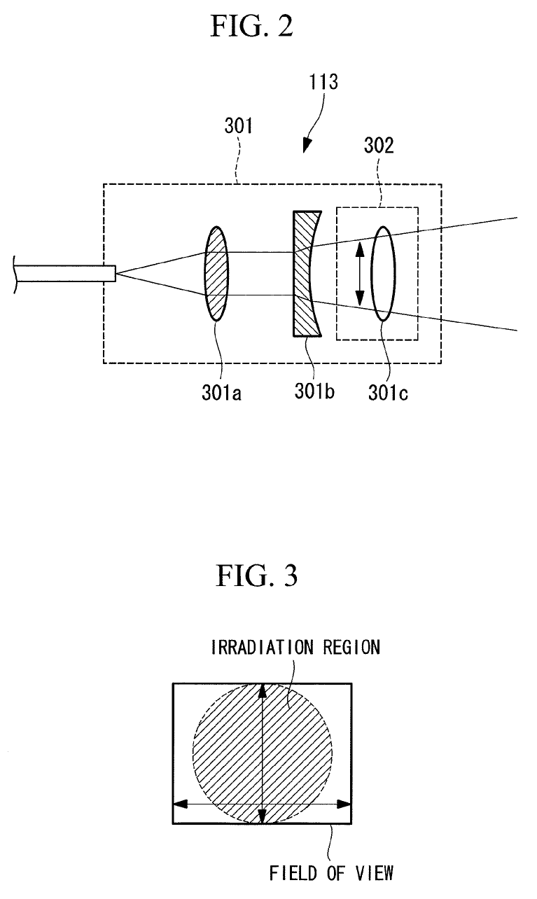

As shown in FIG. 2, the transmitted-light lens system 301 is configured including a lens group formed of a converging lens 301a, a concave lens 301b, and a first lens 301c. The transmitted-light lens system 301 transmits light from the light source and irradiates a surveillance target with the light. Also, the irradiation region is adjusted on the basis of a control signal received from the irradiation scanning controller 27, described later.

Specifically, the transmitted-light lens system 301 is supplied with a control signal from the irradiation scanning controller 27, and the first lens 301c in the transmitted-light lens system 301 is controlled on the basis of this control signal. The first lens 301c is moved along the optical axis on the basis of this control signal so that the size of the irradiation region for the field of view is adjusted.

For example, as shown in FIG. 3, the size of the irradiation region that the first lens 301c irradiates should be set to an irradiation region smaller than the size of the entire field of view. In this way, by performing irradiation in a region smaller than the field of view, it is possible to reduce wasted irradiation energy lying outside the field of view.

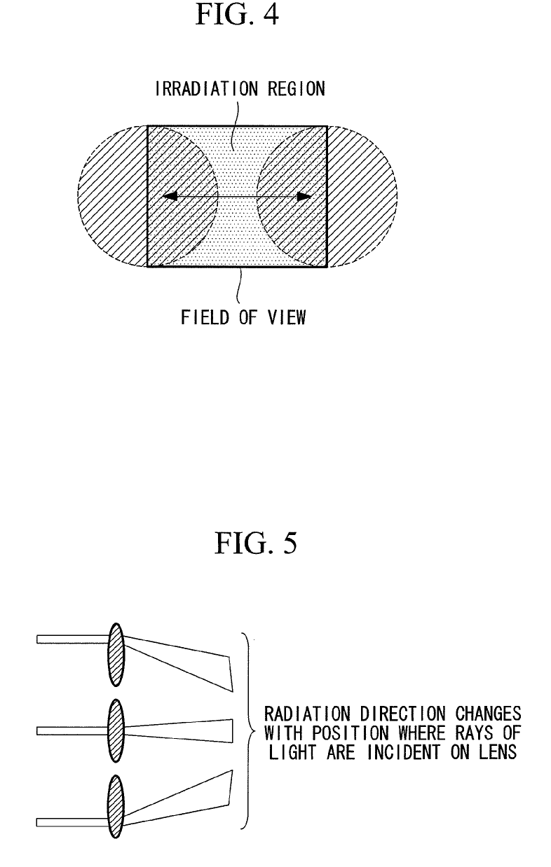

The scanning mechanism 302 scans the irradiation region inside the field of view on the basis of a scanning signal received from the scanning mechanism controller 27, described later. Specifically, the scanning mechanism 302 is the first lens 301c in the transmitted-light lens system 301 disposed on the optical axis. By moving the first lens 301c perpendicularly to the optical axis, it is possible to vary the direction of the light passing through the first lens 301c. By making the first lens 301c reciprocate once in this way, it is possible to scan the irradiation region in a single reciprocation within the field of view as shown in FIG. 4. Specifically, as shown in FIG. 5, it is possible to change the radiation direction in accordance with the incident position of the light rays on the lens, thereby performing scanning.

The scanning mechanism 302 in the image-acquisition apparatus according to this embodiment is assumed to be the first lens 301c in the transmitted-light lens system 301, but it is not limited thereto. For example, a scanning lens may be separately provided at the front surface of the first lens 301c.

The length of the diameter of the irradiation region for the field of view should be set substantially equal to the length of any side (reference side) of the sides constituting the field of view. For example, in the case where the length in the vertical direction of the field of view is defined as the reference side, as shown in FIG. 2, the length of the diameter of the irradiation region is set substantially equal to this reference side, and then the irradiation region is scanned in a direction perpendicular to the reference side. Accordingly, it is possible to irradiate the entire field of view.

The transmitted-light lens actuator adjusts the position of the transmitted-light lens system 301 in the irradiation scanning section 113 on the basis of the control signal supplied from the laser-radar control unit 2, described later. Thus, the angle of the laser light incident on the transmitted-light lens system 301 can be adjusted, and the laser light can be emitted in a desired area.

The light-receiving portion 12 is configured to include, for example, an ICCD (image intensifier CCD) camera head 121, the received-light shutter 122, and a zoom lens 123. The zoom lens 123 collects the reflected light, which is the light emitted from the light-transmitting portion 11 and reflected by the image-acquisition target, and guides the reflected light to the received-light shutter 122. The received-light shutter 122 is formed, for example, of a high-speed gating device that can open and close at high speed and is driven by the shutter-device control section 24 provided in the laser-radar control unit 2, described later, so that the light guided by the zoom lens 123 shines on the CCD camera head 121 or is blocked. The ICCD camera head 121 generates an image signal by converting the acquired light into an electrical signal and outputs this image signal to an image processing device 25 in the laser-radar control unit 2. The laser radar 1 has a structure in which the rotation angle and pitch angle thereof are adjusted to desired angles by means of a swiveling base 5.

During image acquisition, when an image-acquisition field of view is input to the control device 3 from an input device (not illustrated), the control device 3 supplies information about this image-acquisition field of view to the laser-radar control unit 2. Then, the control device 3 generates a synchronous control signal required for emitting the laser light with a prescribed timing, a shutter driving signal for capturing, at the ICCD camera head 121 provided in the light-receiving portion 12, only the reflected light, which is the laser light that is emitted at the prescribed timing reaching the prescribed object and being reflected therefrom, and so forth, and outputs them to the laser-radar control unit 2.

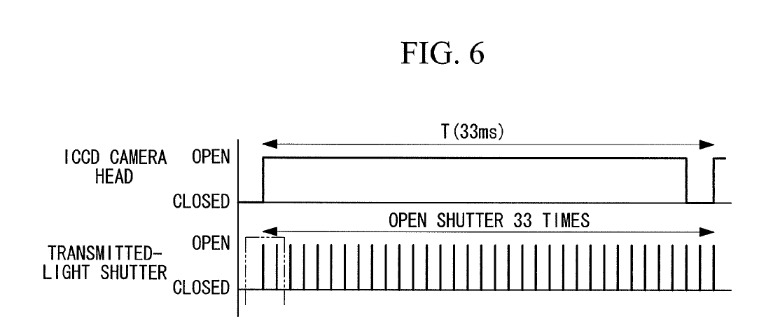

As shown in FIG. 6, the control device 3 controls the laser-radar control unit 2 so as to open at the shutter timing of the transmitted-light shutter 112 with a prescribed pulse cycle in one frame period T. In this embodiment, the ICCD camera head 121 outputs an image in NTSC format and outputs an image signal at 30 Hz; in other words, it outputs 30 still images per second. Therefore, in this embodiment, one frame period T is about 33 ms ( 1/30 second).

FIG. 6 shows a timing chart in the case where, with one frame period T taken as 33 ms, the transmitted-light shutter 112 opens 33 times in this one frame period T; however, the cycle at which the shutter opens is not limited to this cycle.

Also, the cycle at which the shutter opens is preferably set to be as short as possible. By setting a short cycle in this way, it possible to increase the number of images in one frame period T, and therefore, it is possible to obtain acquired images with higher brightness.

The laser-radar control unit 2 controls the light-transmitting portion 11 and the light-receiving portion 12 of the laser radar 1 and the swiveling base 5 on the basis of the individual control signals supplied from the control device 3. The laser-radar control unit 2 includes, for example, a swiveling-base driving section 21, a synchronizing circuit 22, a control-signal converting device 23, the shutter-device control section 24, the image processing device 25, the laser power supply 26, and the irradiation scanning controller 27.

The laser-radar control unit 2 and the control device 3 have built-in computer systems including, for example, a CPU (central processing unit), HD (Hard Disc), ROM (Read Only Memory), RAM (Random Access Memory), and so on. A series of processing procedures for realizing the individual functions described later is stored in the HD or ROM etc. in the form of a program, and the CPU loads this program into RAM etc. and executes information processing or computational processing, thereby realizing the individual functions described later.

The synchronization control signal and the shutter driving signal output from the control device 3 are respectively supplied to the synchronizing circuit 22 and the shutter-device control section 24 via the control-signal converting device 23 in the laser-radar control unit 2.

On the basis of the input synchronization control signal, the synchronizing circuit 22 generates a synchronization signal for achieving synchronization between the transmitted and received laser light and outputs this synchronization signal to the laser power supply 26 and the shutter-device control section 24.

The laser power supply 26 generates an activation signal for the laser oscillator 111 in the light-transmitting portion 111 provided in the laser radar 1 on the basis of the synchronization signal supplied from the synchronizing circuit 22 and drives the laser oscillator 111 on the basis of this activation signal.

On the other hand, the shutter-device control section 24 drives the received-light shutter 122 in the light-receiving portion 12 provided in the laser radar 1 on the basis of the shutter driving signal input from the control device 3 and the synchronization signal input from the synchronizing circuit 22.

The image processing device 25 accumulates image signals output from the ICCD camera head 121 over one frame period and superimposes a plurality of acquired image signals to create an acquired image. The acquired image created by the image processing device 25 is arranged to be output to the display device 4 via the control device 3.

The irradiation scanning controller 27 sets the irradiation region appropriate for the image-acquisition field of view to be captured, which serves as input information, and adjusts the position of the transmitted-light lens system 301 in the irradiation scanning section 113 so that the light is radiated onto the set irradiation region. It also performs control of the scanning mechanism 302 in the irradiation scanning section 113 so that that irradiation region is scanned inside the field of view.

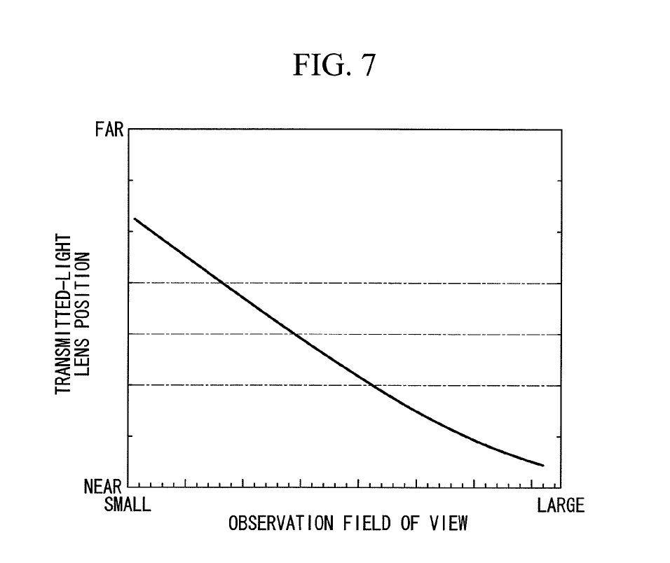

Regarding setting of the irradiation region appropriate for the image-acquisition field of view, for example, the irradiation scanning controller 27 may possess a table in which the image-acquisition field of view and the irradiation region appropriate therefor are associated with each other, and may set the irradiation region appropriate for the image-acquisition field of view by referring to this table. In another possible configuration, instead of the table described above, it may possess a table in which the image-acquisition field of view and the position of the transmitted-light lens system 301 are directly associated with each other, and the position of the transmitted-light lens system 301 is directly obtained from this table. An example of this table in which the image-acquisition field of view and the transmitted-light lens system 301 are associated with each other is shown in FIG. 7. In FIG. 7, the vertical axis is the position of the transmitted-light lens system 301, and the horizontal axis is the image-acquisition field of view. As shown in this figure, if the image-acquisition field of view is determined, it is possible to uniquely determine the position of the transmitted-light lens.

The display device 4 includes a display monitor (not illustrated) that displays the acquired image etc. output from the control device 3.

Next, the operation of the image-acquisition apparatus according to this embodiment will be described.

First, during image acquisition, when the image-acquisition field of view is input to the control device 3 from the input device (not illustrated), the control device 3 supplies information about this image-acquisition field of view to the laser-radar control unit 2.

The control device 3 generates a synchronization control signal required for continuously emitting pulsed laser light at a prescribed pulse cycle. Also, the control device 3 generates, among others, a shutter driving signal for causing the transmitted-light shutter 112 to open at the prescribed cycle for passing the laser light continuously emitted from the laser oscillator, so that the light-receiving portion 12 acquires only the reflected light, which is the pulsed laser light that reaches the object located at the image-acquisition distance and is reflected therefrom, and these are output to the laser-radar control unit 2.

The information about the image-acquisition field of view output from the control device 3 is supplied to the irradiation scanning controller 27 in the laser-radar control unit 2.

An irradiation region appropriate for the image-acquisition field of view obtained as input information is set in the irradiation scanning controller 27, and a driving signal is generated for adjusting the position of the first lens 301c in the transmitted-light lens system 301 so that the irradiation region is irradiated with light. The generated driving signal is output to the transmitted-light lens actuator (not illustrated), and the position of the first lens 301c is adjusted by the transmitted-light lens actuator.

Also, in the irradiation scanning controller 27, a scanning signal for driving the scanning mechanism 302 on the basis of the irradiation region appropriate for the image-acquisition field of view is generated and is output to the scanning mechanism 302 (in this embodiment, the first lens 301c also functions as the scanning mechanism). The first lens 301c, that is, the scanning mechanism 302, is moved in a direction perpendicular to the optical axis on the basis of the received scanning signal for scanning the irradiation region within the entire field of view.

Next, the synchronization control signal and the shutter driving signal output from the control device 3 are respectively supplied to the synchronization circuit 22 and the shutter-device control section 24 via the control-signal converting device 23 in the laser-radar control unit 2.

In the synchronizing circuit 22, a synchronization signal is generated for achieving synchronization between the transmitted and received laser light on the basis of the input synchronization control signal, and this synchronization signal is output to the laser power supply 26 and the shutter-device control section 24.

In the laser power supply 26, an activation signal for the laser oscillator 111 in the light-transmitting portion 11 provided in the laser radar 1 is generated on the basis of the synchronization signal supplied from the synchronizing circuit 22, and the laser oscillator 111 is driven on the basis of this activation signal.

In the shutter-device control section 24 on the other hand, the received-light shutter 122 in the light-receiving portion 12 provided in the laser radar 1 is driven on the basis of the shutter driving signal input from the control device 3 and the synchronization signal input from the synchronizing circuit 22.

Accordingly, the transmitted-light shutter 112 is driven by the laser power supply 26, and thereby, the continuous laser light from the laser oscillator 111 is emitted as pulsed laser light with a prescribed pulse cycle. This laser light is expanded to a size according to the position of the lens 301c provided in the irradiation scanning section 113, and then the lens 301c is moved by reciprocating it at a prescribed speed in a direction perpendicular to the optical axis, thereby successively changing the irradiation direction.

The light emitted from the light-transmitting portion 11 is reflected by an object existing in the irradiation region, and this reflected laser light is guided in the light-receiving portion 12. In this case, by driving the received-light shutter 122 with the shutter-device control section 24 on the basis of the shutter driving signal, it is possible to sequentially acquire, at the ICCD camera head 121, only the laser light reflected by the object located at a prescribed image-acquisition distance.

Information about the reflected light acquired by the ICCD camera head 121 is converted to an image signal, which is an electrical signal, and is output to the image processing device 25 in the laser-radar control unit 2. The image-processing device 25 accumulates a plurality of images generated on the basis of the reflected light acquired by opening/closing the received-light shutter 122, in one frame period T from when the ICCD camera head 121 opens until when it closes. Then, a high-brightness acquired image is created by summing (superimposing) the plurality of accumulated images, and this acquired image is output.

The acquired image created by the image-processing device 25 is input to the control device 3 via the control-signal converting device 23. The control device 3 outputs the input acquired image to the display device 4. Accordingly, for example, the outline of a floating object etc. located at the image-acquisition distance is clearly (with high brightness) displayed on the display monitor of the display device 4 in the form of visible information. As a result, the crew or other persons can obtain information such as the shape and size of an object existing in the irradiation region by checking the image displayed on the display monitor.

As described above, with the image-acquisition apparatus according to this embodiment, the irradiation region for the field of view is made smaller than the size of the entire field of view, and this irradiation region is scanned in the field of view to irradiate the entire field of view with light. Thus, because the region where a part other than the field of view is irradiated is reduced, it is possible to reduce the amount of wasted irradiation energy compared with the conventional method in which the entire field of view is irradiated.

In addition, when the field of view is enlarged, the required irradiation energy is increased compared with before enlarging the field of view. However, even when the field of view is enlarged, by scanning the irradiation region which is smaller in size than the field of view, compared with the conventional method in which the entire field of view is irradiated, it is possible to reduce the increase in energy required when the field of view is enlarged.

### Modifications

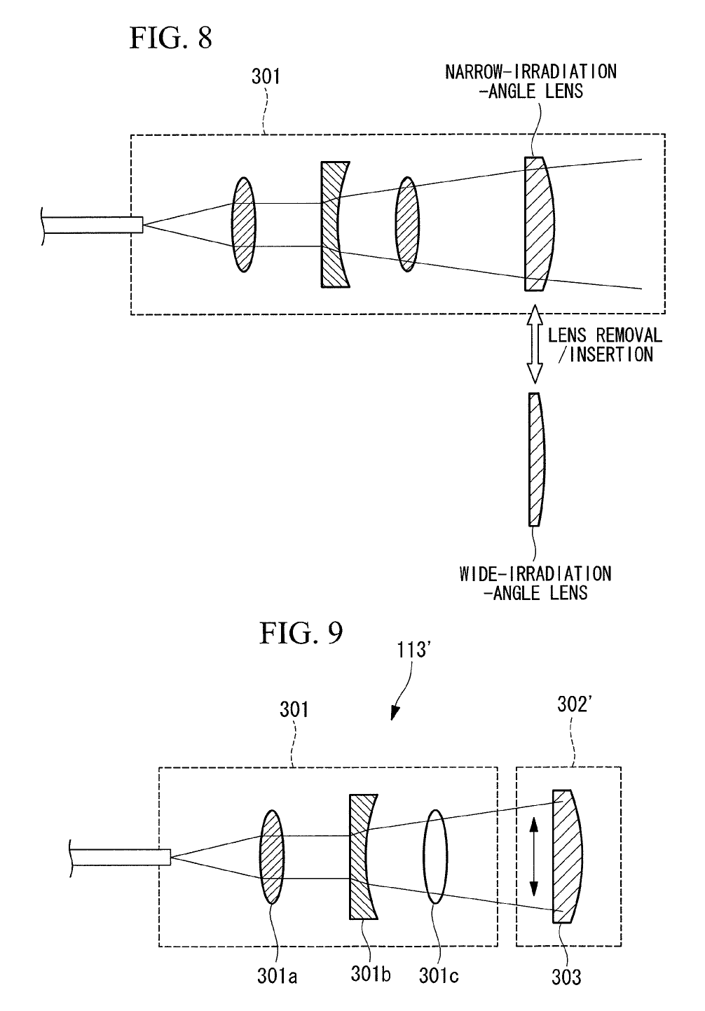

In the image-acquisition apparatus according to this embodiment, the transmitted-light lens system 301 adjusts the size of the irradiation region for the field of view by moving the lens disposed on the optical axis parallel to the optical axis; however, it is not limited thereto. For example, instead of moving the lens parallel to the optical axis, as shown in FIG. 8, the transmitted-light lens system 301 may be provided with at least two lenses with different irradiation angles that can be inserted on the optical axis and may select one of the lenses and insert it on the optical axis, thereby adjusting the size of the irradiation region for the field of view.

By doing so, it is possible to adjust the irradiation region for the field of view with a simple method.

The lens group of the image-acquisition apparatus according to this embodiment is composed of three lenses of three different kinds; however, the kinds and number of lenses provided in the lens group are not limited thereto.

In the image-acquisition apparatus according to this embodiment, the irradiation scanning section 113 scans the irradiation region for the field of view by moving the first lens 301c in a direction perpendicular to the optical axis; however, it is not limited thereto. For example, of the lenses provided in the lens group of the irradiation scanning section 113 disposed on the optical axis, any single lens may be moved in a direction perpendicular to the optical axis, or a plurality of lenses may be moved simultaneously in a direction perpendicular to the optical axis. In addition, the lens moving speed may be made adjustable.

In the image-acquisition apparatus according to this embodiment, the irradiation scanning section 113 is illustrated by an example case in which the irradiation region is reciprocated once inside the field of view by reciprocating it once in a direction perpendicular to the optical axis; however, the number of reciprocations of the first lens 301c is not particularly limited.

In addition, in the image-acquisition apparatus according to this embodiment, the speed at which the first lens 301c of the transmitted-light lens system 301 is moved in a direction perpendicular to the optical axis may be made adjustable. For example, when it is desired to reduce noise in the acquired image, the moving speed of the first lens 301c is increased, increasing the number of scans. By doing so, the number of times that the field of view is irradiated per unit time is increased. Thus, it is possible to obtain a brighter image, and it is possible to obtain a higher-quality image.

The moving speed may be adjusted, for example, to satisfy the desired image quality. The determination of whether or not the image quality has reached a fixed quality may be based on human vision or it may be an automatic determination carried out by some mechanism. For example, when performing automatic determination with some mechanism, the determination may be made using a value based on the SN ratio (Signal to Noise ratio).

In the image-acquisition apparatus according to this embodiment, the transmitted-light shutter 112 is provided between the laser oscillator 111 and the irradiation scanning section 301, and by performing opening/closing control of this transmitted-light shutter 112 in synchronization with the received-light shutter 122 provided in the light-receiving portion 12, the irradiation timing of the laser light emitted from the light-transmitting portion 11 is controlled; instead of this, however, the laser-light emission timing of the laser oscillator 111 may be controlled, for example, with an electrical signal that is synchronized with the received-light shutter 122. By controlling the timing of laser-light emission by the laser oscillator 111 in this way, the transmitted-light shutter 112 becomes unnecessary, making it possible to achieve a simplified apparatus.

### Second Embodiment

Next, a second embodiment of the present invention will be described using FIG. 9.

The difference between the image-acquisition apparatus of this embodiment and the first embodiment is that an irradiation scanning section 113′ is provided instead of the irradiation scanning section 113 (see FIG. 9), and the irradiation scanning section 113′ includes a beam-shape modifying section 303. With regard to the image-acquisition apparatus of this embodiment, in what follows, a description of commonalities with the first embodiment will be omitted, and mainly the differences will be described.

A scanning mechanism 302′ is provided with the beam-shape modifying section 303. As shown in FIG. 9, the beam-shape modifying section 303 is provided at the front surface of the first lens 301c for the case where the light travelling direction is assumed to be to the front.

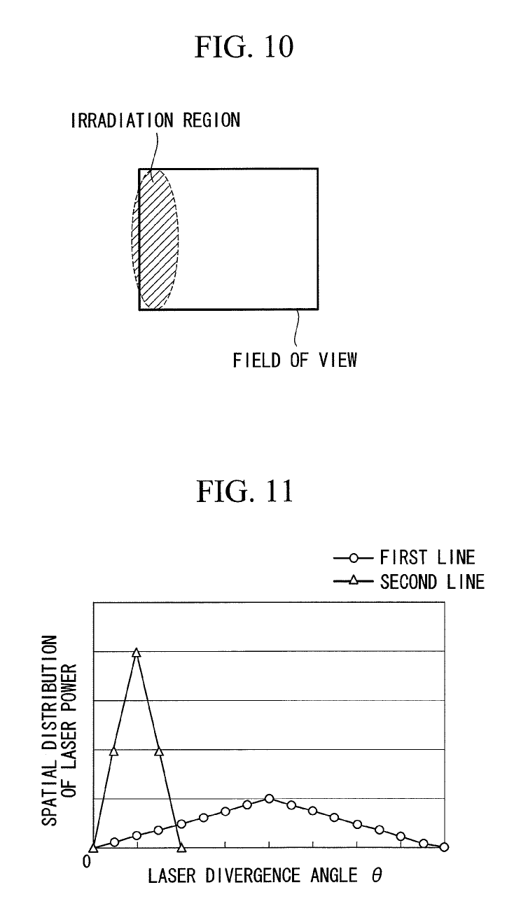

The beam-shape modifying section 303 modifies the cross-sectional shape, taken by cutting through the light output from the light source in a direction perpendicular to the optical axis, into an ellipse or straight line and also has a function for making the irradiation region for the field of view smaller than the size of the entire field of view to reduce the area of the cross-sectional shape. Thus, when using the beam-shape modifying section 303, because the irradiation energy is more concentrated compared with a case where the beam-shape modifying section 303 is not used, it is possible to increase the brightness of the irradiation region. For example, when a cylindrical lens is used as the beam-shape modifying section 303, as shown in FIG. 10, it is possible to make the shape of the irradiation region vertically elongated ellipse.

Besides the above-described cylindrical lens, a slit or the like may be used in the beam-shape modifying section 303.

As a more concrete example, FIG. 11 shows the width of the field of view on the horizontal axis and the laser output power on the vertical axis. FIG. 11 is a graph of the relationship between the horizontal direction in the field of view and the brightness information, where the first line is for the case where the entire field of view is irradiated, as in the conventional approach, and the second line is for the case of elliptical irradiation in this embodiment. As is clear from FIG. 11, when using the beam-shape modifying section 303 in FIG. 9, although the region that can be irradiated in a single irradiation is narrower compared with the conventional approach, it is possible to increase the brightness.

Next, brightness information for cases where field-angle scanning is performed when a cylindrical lens (beam-shape modifying section 303) is used and where field-angle scanning of the entire field of view when a cylindrical lens is not used will be described.

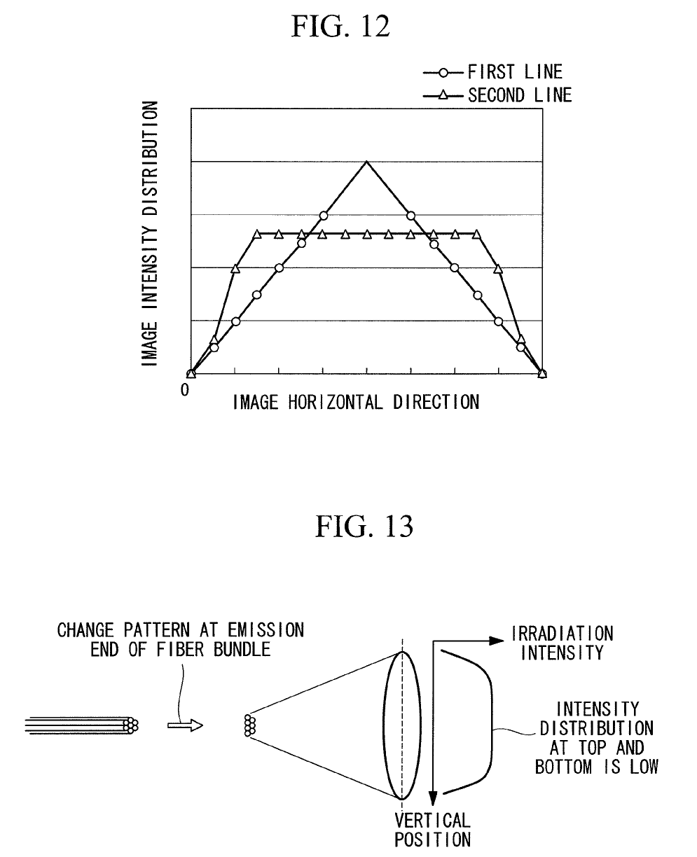

FIG. 12 shows the horizontal direction of the field of view on the horizontal axis and the brightness distribution of the image on the vertical axis.

FIG. 12 shows the distribution of brightness information, where the first line is for the case where the entire field of view is irradiated, as in the conventional approach, and the second line is for the case where an elliptical irradiation region of this embodiment is scanned over the entire field of view. As is clear from FIG. 12, in the case where the irradiation region is not scanned, the brightness at the center of the field of view is higher, and the brightness decreases as the distance from the center increases. In contrast, when field-angle scanning is performed using the beam-shape modifying section 303 according to this embodiment, although the absolute value of the brightness at the center of the field of view decreases, as shown by the second line, the brightness in the field of view can be made substantially uniform.

When the irradiation region is made elliptical by concentrating the irradiation region in this way, it is possible to increase the brightness within the field of view with the same output power as in the case of a circular irradiation region. In addition, by scanning the irradiation region with this high-brightness state in the field of view, it is possible to acquire an image in which the entire field of view is brightly irradiated.

For example, the location of the target may be uncertain, as in the case of searching for a target at sea. In such a case, the brightness of the entire field of view should be increased to make the entire field of view bright. Accordingly, the target object can be searched for more easily compared with an image in which mainly the vicinity of the center of the field of view is bright and the edges of the field of view have lower brightness than the center, as is the case with the conventional approach.

As described above, with the image-acquisition apparatus according to this embodiment, by using the beam-shape modifying section 303, it is possible to change the cross-sectional shape, obtained by cutting through the light output from the light source in a direction perpendicular to the optical axis, and the area can be reduced. Accordingly, it is possible to make the irradiation region brighter. In addition, by scanning the brighter irradiation region within the field of view, it is possible to obtain an acquired image in which the entire field of view is substantially uniformly bright.

### Modifications

In this embodiment the irradiation region in the light incident from the light source is modified by the beam-shape modifying section 303; however, it is not limited thereto. For example, as shown in FIG. 13, by bundling an optical fiber bundle that guides the light emitted from the light source so that the cross-sectional shape at the output end thereof is elliptical, the irradiation region emitted from this optical fiber bundle may be formed in an elliptical shape.

Thus, the beam-shape modifying section 303 becomes unnecessary, and it is possible to increase the brightness of the irradiation region in a simple manner and to scan it within the field of view.

At the top and bottom of the irradiation region in the case where it is formed into an elliptical shape by means of the optical fiber bundle, the intensity distribution of the radiation is reduced compared with the case of beam shaping with a cylindrical lens. Thus, it is possible to acquire an image that is bright over a larger area.

### Third Embodiment

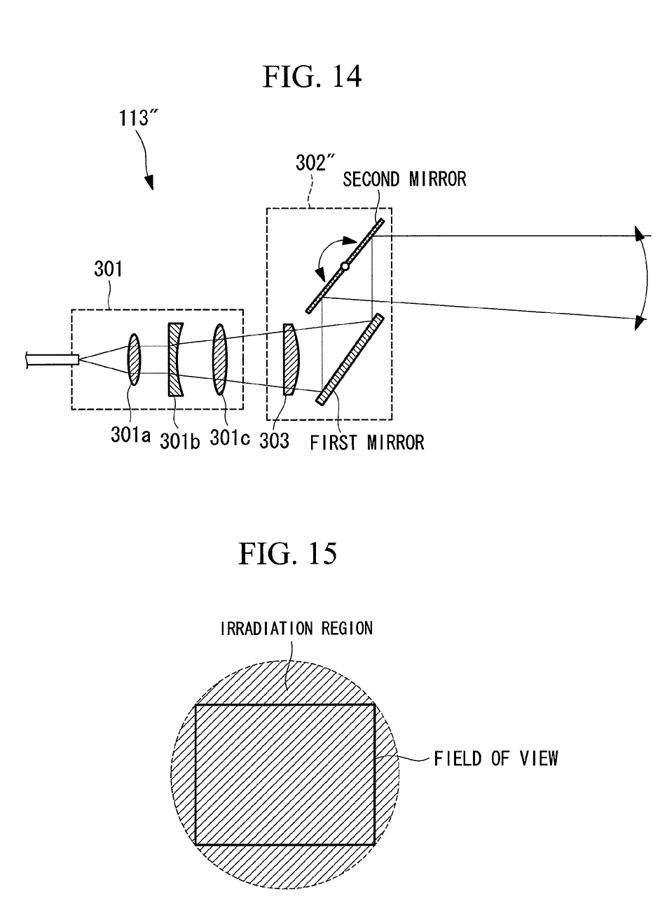

Next, a third embodiment of the present invention will be described using FIG. 14.

In this embodiment, an irradiation scanning section 113″ (see FIG. 14) is provided instead of the irradiation scanning section 113 in FIG. 1 of the first embodiment, and the irradiation scanning section 113″ includes a scanning mechanism 302″.

The image-acquisition apparatus of this embodiment differs from the first embodiment and the second embodiment in that the scanning of the irradiation region in the field of view is performed by a mirror provided in the scanning mechanism 302″. In the following, a description of commonalities with the first and second embodiments will be omitted, and mainly the differences will be described.

The irradiation scanning section 113″ includes a first mirror that reflects light from the light source and a second mirror that reflects the light that the first mirror has reflected.

The irradiation scanning section 113″ rotates the second mirror on the basis of a control signal received from the irradiation scanning controller 27 to scan the irradiation region within the field of view by changing the irradiation angle of the light. The second mirror is, for example, a galvanometer mirror.

Accordingly, it is possible to scan the irradiation region for the field of view with a simple method, without moving a lens.

The speed at which the second mirror is rotated may be made adjustable. Thus, when the rotation speed of the second mirror is increased, for example, the number of times the field of view is irradiated per unit time is increased. Accordingly, it is possible to obtain a brighter image, and it is possible to obtain a higher-quality image.

### REFERENCE SIGNS LIST

1 laser radar
2 laser-radar control unit
3 control device
4 display device
5 swiveling base
27 irradiation scanning controller
111 laser oscillator
112 transmitted-light shutter
113, 113′, 113″ irradiation scanning section
121 ICCD camera head
122 received-light shutter
123 zoom lens
301 transmitted-light lens system
302 scanning mechanism
303 beam-shape modifying section

1. An image-acquisition apparatus comprising:
a light-transmitting portion that radiates light; and
a light-receiving portion that receives reflected light, which is the light emitted from the light-transmitting portion being reflected upon reaching a target, and that converts the obtained reflected light to an image signal and outputs the image signal,
wherein the light-transmitting portion includes
a light source; and
an irradiation scanning section that makes the length of the diameter of an irradiation region for a field of view substantially equal to the length of one of the sides constituting the field of view to make the irradiation region for the field of view smaller than the size of the entire field of view and that irradiates the entire field of view with light by scanning the irradiation region for the field of view within the field of view.

2. (canceled)

3. An image-acquisition apparatus according to claim 1, wherein the irradiation scanning section includes a lens, and
moves the lens parallel to an optical axis to adjust the size of the irradiation region for the field of view.

4. An image-acquisition apparatus according to claim 1, wherein the irradiation scanning section
includes at least two lenses with different irradiation angles which can be inserted on an optical axis, and
adjusts the size of the irradiation region for the field of view by selecting one of the lenses and inserting the selected lens on the optical axis.

5. An image-acquisition apparatus comprising:
a light-transmitting portion that radiates light; and
a light-receiving portion that receives reflected light, which is the light emitted from the light-transmitting portion being reflected upon reaching a target, and that converts the obtained reflected light to an image signal and outputs the image signal,
wherein the light-transmitting portion includes
a light source; and
an irradiation scanning section that defines any one of the sides constituting the field of view as a reference side and makes the length of the diameter of the irradiation region for the field of view substantially equal to the length of the reference side and scans the irradiation region for the field of view in a direction perpendicular to the reference side.

6. An image-acquisition apparatus according to claim 1, wherein the irradiation scanning section
includes a lens group including a plurality of lenses arranged on the optical axis, and
moves at least one of the lenses included in the lens group in a direction perpendicular to the optical axis to scan the irradiation region in the field of view.

7. An image-acquisition apparatus according to claim 6, wherein the moving speed of at least one lens of the lens group is adjustable.

8. An image-acquisition apparatus according to claim 1, wherein
the irradiation scanning section includes
a first mirror that reflects light from the light source; and
a second mirror that reflects the light that the first mirror has reflected,
and scans the irradiation region within the field of view while changing the irradiation angle of the light by rotating the second mirror.

9. An image-acquisition apparatus according to claim 8, wherein the speed at which the second mirror is rotated is adjustable.

10. An image-acquisition apparatus according to claim 1, wherein the irradiation scanning section includes a beam-shape modifying section that modifies the cross-sectional shape obtained when cutting through the light output from the light source in a direction perpendicular to the optical axis and that makes the irradiation region for the field of view smaller than the size of the entire field of view to reduce the area of the cross-sectional shape.

11. An image-acquisition apparatus according to claim 1, wherein the light-transmitting portion
includes an optical fiber bundle in which the light emitted from the light source is guided, and
the optical fiber bundle is bundled so that the cross section at the output end thereof is elliptical.

12. An image-acquisition method comprising:
a step of radiating light;
a step of receiving reflected light, which is the emitted light reflected upon reaching a target, converting the obtained reflected light to an image signal, and outputting the image signal; and
a step of making the length of an irradiation region for a field of view substantially equal to the length of any one of the sides constituting the field of view to make the irradiation region for the field of view smaller than the size of the entire field of view, and irradiating the entire field of view with light by scanning the irradiation region for the field of view in the field of view.

13. An image-acquisition apparatus according to claim 5, wherein the irradiation scanning section
includes a lens group including a plurality of lenses arranged on the optical axis, and
moves at least one of the lenses included in the lens group in a direction perpendicular to the optical axis to scan the irradiation region in the field of view.

14. An image-acquisition apparatus according to claim 5, wherein
the irradiation scanning section includes
a first mirror that reflects light from the light source; and
a second mirror that reflects the light that the first mirror has reflected,
and scans the irradiation region within the field of view while changing the irradiation angle of the light by rotating the second mirror.

15. An image-acquisition apparatus according to claim 14, wherein the speed at which the second mirror is rotated is adjustable.

16. An image-acquisition apparatus according to claim 5, wherein the irradiation scanning section includes a beam-shape modifying section that modifies the cross-sectional shape obtained when cutting through the light output from the light source in a direction perpendicular to the optical axis and that makes the irradiation region for the field of view smaller than the size of the entire field of view to reduce the area of the cross-sectional shape.

17. An image-acquisition apparatus according to claim 5, wherein the light-transmitting portion
includes an optical fiber bundle in which the light emitted from the light source is guided, and
the optical fiber bundle is bundled so that the cross section at the output end thereof is elliptical.
